(19) United States
(12) Patent Application Publication
(10) Pub. No.: US 2020/0019026 A1
(43) Pub. Date: Jan. 16, 2020

(54) LIQUID CRYSTAL DISPLAY PANEL

(71) Applicant: SHARP KABUSHIKI KAISHA, Sakai City (JP)

(72) Inventor: MASAKATSU TOMINAGA, Sakai City (JP)

(21) Appl. No.: 16/449,125

(22) Filed: Jun. 21, 2019

Related U.S. Application Data
(60) Provisional application No. 62/695,955, filed on Jul. 10, 2018.

(51) Int. Cl. G02F 1/1343; G02F 1/1337

(52) U.S. Cl. CPC G02F 1/134363; G02F 1/133753

(57) ABSTRACT

A liquid crystal panel includes a first substrate, a second substrate, and a liquid crystal layer sandwiched between the first substrate and the second substrate. The first substrate includes pixel electrodes having a longitudinal shape and arranged along at least a short side direction thereof, and a common electrode disposed to overlap the pixel electrodes. The second substrate is disposed opposite the first substrate and includes a counter electrode. The counter electrode extends along a long side direction of the pixel electrodes and has a width greater than a spacing between the pixel electrodes adjacent to each other in the short side direction and selectively overlaps ends in the short side direction of the pixel electrodes adjacent to each other in at least the short side direction.

### CROSS REFERENCE TO RELATED APPLICATION

This application claims priority from U.S. Provisional Patent Application No. 62/695,955 filed on Jul. 10, 2018. The entire contents of the priority application are incorporated herein by reference.

### TECHNICAL FIELD

The present technology described herein relates to a liquid crystal panel.

### BACKGROUND ART

A conventionally-known example of a liquid crystal display device is disclosed in Japanese Unexamined Patent Application Publication No. 2001-91974. The liquid crystal display device is structured such that one of two substrates opposed to each other with a liquid crystal layer sandwiched therebetween has an opposed surface formed with source lines and gate lines arranged in a matrix, switching elements provided in correspondence with each separate intersection between the source lines and the gate lines, pixel electrodes connected to the switching elements, and a common electrode opposed to the pixel electrodes and formed along the source lines, and in this structure, the other of the pair of substrates has an electric-field control electrode provided thereon, and the electric-field control electrode is placed so as to cover edge portions of the source lines.

Since the above liquid crystal display device includes the electric-field control electrode placed so as to cover the edge portions of the source lines, the electric-field control electrode generates vertical electric fields in gap portions between the source lines and the adjacent common electrode or pixel electrodes. This raises liquid crystal molecules to bring the gap portions into a black state to eliminate leakage of light, bringing about improvement in contrast.

Thus, in the above liquid crystal display device, it is intended to provide a solution to leakage of light due to unwanted electric fields generated from the edges of the source lines. However, for example, when longitudinally-shaped pixel electrodes adjacent to each other in a short side direction thereof are located close to each other, strong electric fields are generated between ends of adjacent pixel electrodes that extend along a long side direction thereof and the orientation of liquid crystal molecules contained in the liquid crystal layer is disrupted due to the electric fields, with the result that a gradation display differing from what it was originally expected to be might be performed.

### SUMMARY

The present technology described herein was made in view of the above circumstances. An object is to optimize a gradation display.

A liquid crystal panel according to the technology described herein includes a first substrate including a plurality of pixel electrodes that have a longitudinal shape and are arranged along at least a short side direction thereof, and a common electrode disposed to overlap the plurality of pixel electrodes, a second substrate disposed opposite the first substrate and including a counter electrode, the counter electrode extending along a long side direction of the pixel electrodes and having a width greater than a spacing between the pixel electrodes adjacent to each other in the short side direction and selectively overlapping ends in the short side direction of the pixel electrodes adjacent to each other in at least the short side direction, and a liquid crystal layer sandwiched between the first substrate and the second substrate.

The present technology described herein makes it possible to optimize a gradation display.

### BRIEF DESCRIPTION OF THE DRAWINGS

FIG. 1 is a plan view of a liquid crystal panel and the like according to Embodiment 1.

FIG. 2 is a cross-sectional view of the liquid crystal panel.

FIG. 3 is a plan view showing an array of pixels in a display region of the liquid crystal panel.

FIG. 4 is a cross-sectional view of the liquid crystal panel as taken along line A-A in FIG. 3.

FIG. 5 is a cross-sectional view of the liquid crystal panel as taken along line B-B in FIG. 3.

FIG. 6 is a diagram showing a graph that represents a relationship between the value of voltage applied to a pixel electrode and the light transmittance of the pixel electrode.

FIG. 7 is a cross-sectional view of pixels as taken along an X-axis direction in a display region of a liquid crystal panel according to Embodiment 2.

FIG. 8 is a cross-sectional view of pixels as taken along an X-axis direction in a display region of a liquid crystal panel according to Embodiment 3.

FIG. 9 is a cross sectional view of pixels as taken along an X-axis direction in a display region of a liquid crystal panel according to Embodiment 4.

FIG. 10 is a cross-sectional view of pixels as taken along an X-axis direction in a display region of a liquid crystal panel according to Embodiment 5.

FIG. 11 is a cross-sectional view of pixels as taken along an X-axis direction in a display region of liquid crystal panel according to Embodiment 6.

FIG. 12 is a plan view showing an array of pixels in a display region of a liquid crystal panel according to another embodiment (1).

### DETAILED DESCRIPTION

### Embodiment 1

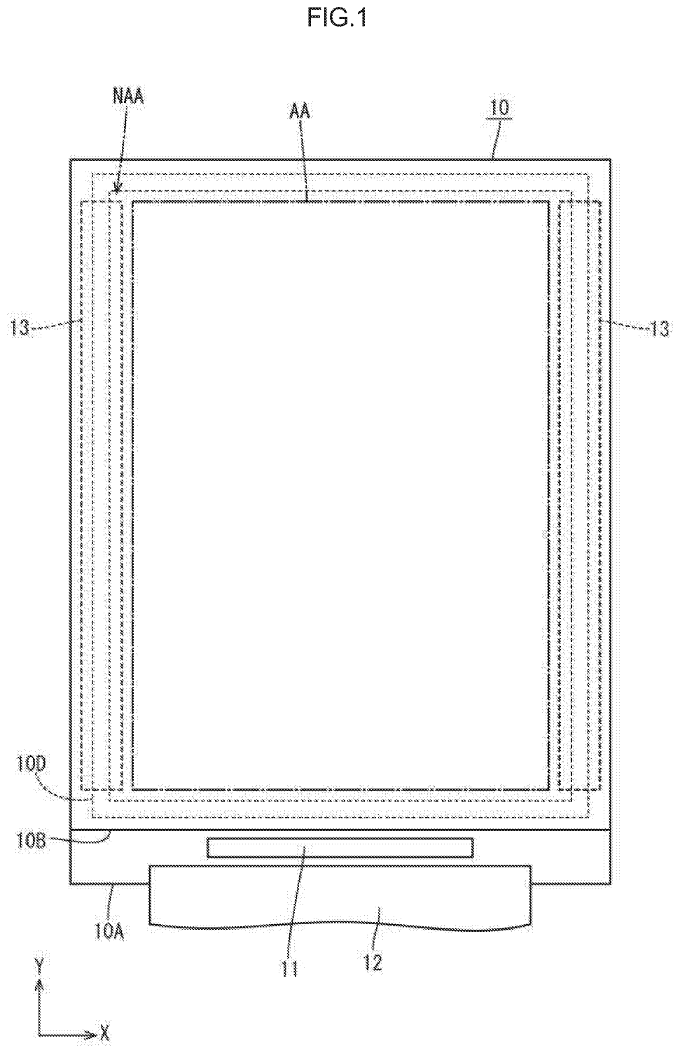

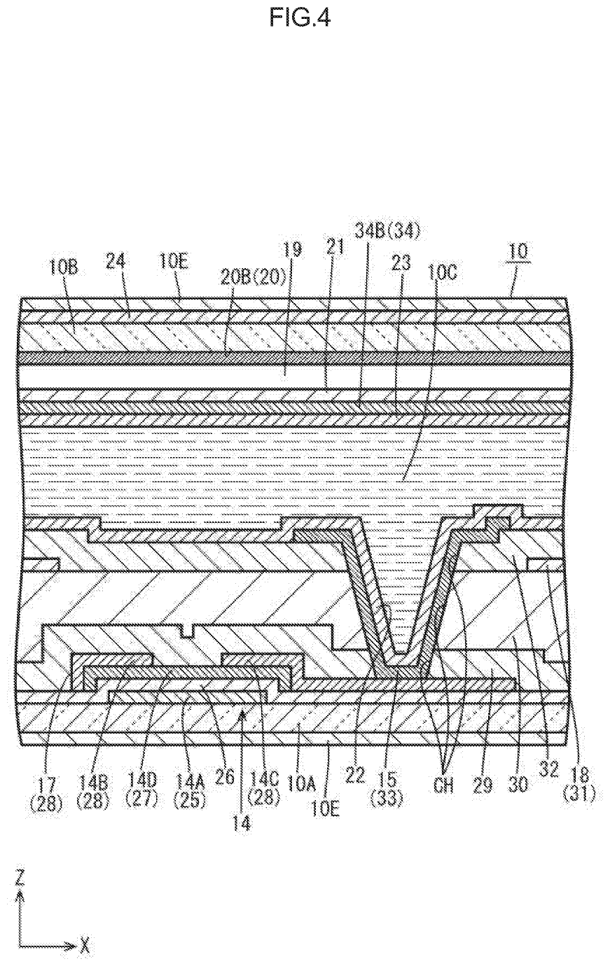

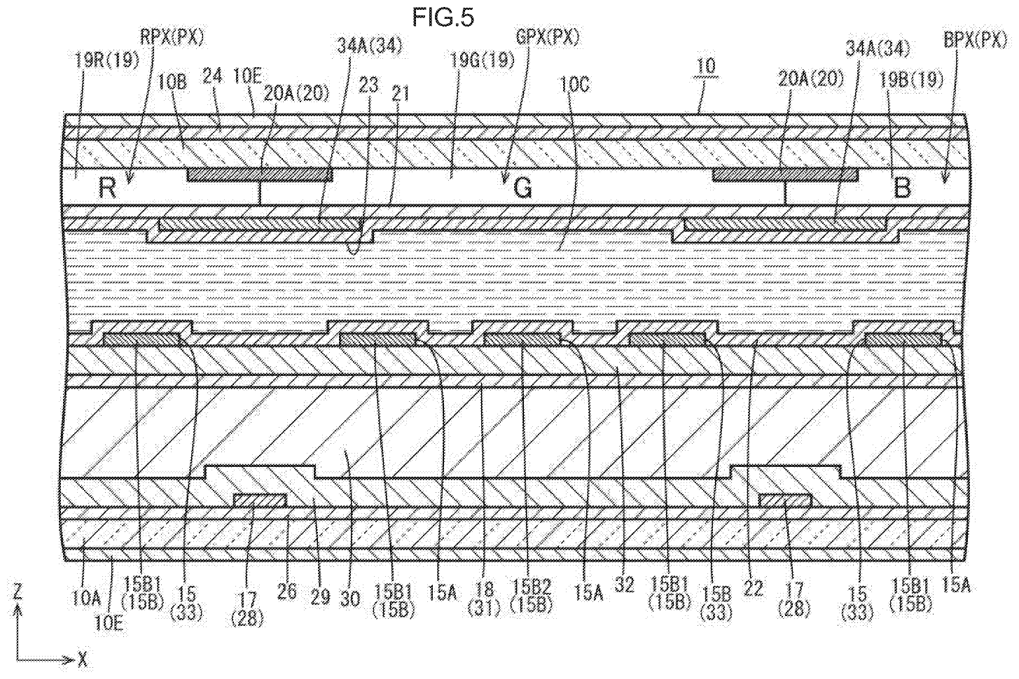

Embodiment 1 will be described with reference to FIGS. 1 to 6. The present embodiment illustrates a liquid crystal panel 10. This liquid crystal panel 10 serves to display an image through the use of light from a backlight device (lighting device). It should be noted that some of the drawings show an X axis, a Y axis, and a Z axis and are drawn so that the direction of each axis is an identical direction in each drawing. Further, FIGS. 4 and 5 show the front side up and the back side down.

As shown in FIG. 1, the liquid crystal panel 10 has, for example, a vertically long square shape as a whole. The liquid crystal panel 10 is mounted with a driver (panel driving section, driving circuit section) 11 that drives the liquid crystal panel 10 and a flexible substrate 12 having one end connected to the liquid crystal panel 10. The driver and the flexible substrate 12 are mounted on the liquid crystal panel 10 via an ACF (anisotropic conductive film). Connected to an end of the flexible substrate 12 opposite to the liquid crystal panel 10 is a control circuit board serving as a signal supply source that externally supplies various types of input signal.

As shown in FIG. 1, the liquid crystal panel 10 has a center side serving as a display region (active area) AA that is capable of displaying an image and an outer peripheral side serving as a non-display region (non-active area) NAA, formed in the shape of a frame in a plan view so as to surround the display region AA, where no image is displayed. In the present embodiment, the liquid crystal panel 10 has its short side direction corresponding to the X-axis direction of each drawing, its long side direction. corresponding to the Y-axis direction of each drawing, and its plate thickness direction corresponding to the Z-axis direction of each drawing. It should be noted that in FIG. 1, the display region AA has its outer shape indicated by alternate long and short dashed lines, and the non-display region NAA is a region that lies outside the alternate long and short dashed lines. Further, the liquid crystal panel 10 has a gate circuit section 13 provided in the non-display region NAA. The gate circuit section 13 is in the shape of belt that extends along the Y-axis direction, and a pair of the gate circuit sections 13 are disposed so that the display AA is interposed from both sides in the X-axis direction. The gate circuit sections 13 serve to supply scanning signals to wires (specifically, the after-mentioned gate lines 16) of the display region AA. The gate circuit sections 13 are monolithically provided on the after-mentioned array substrate 10A, and have circuits that output scanning signals at predetermined timings, buffer circuits for amplifying scanning signals, and the like.

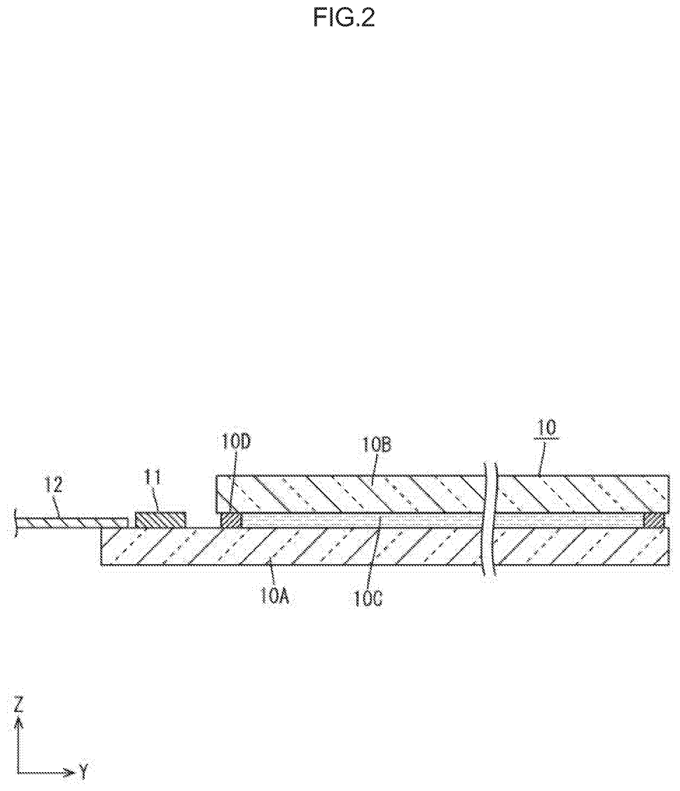

As shown in FIG. 2, the liquid crystal panel 10 includes at least a pair of substrates 10A and 10B, a liquid crystal layer 10C, sandwiched between the two substrates 10A and 10B, that contains liquid crystal molecules constituting a substance whose optical properties vary in the presence of the application of an electric field, and a sealing section 10D, interposed between the pair of substrates 10A and 10B in such a manner as to surround the liquid crystal layer 10C, that seals in the liquid crystal layer 10C. The pair of substrates 10A and 10R, which constitute the liquid crystal panel 10, consist of a bottom (back) substrate serving as an array substrate (first substrate, active matrix substrate, TFT substrate) 10A and a top (front) substrate serving as a CF substrate (second substrate, counter substrate) 10B. The array substrate 10A and the CF substrate 10B each include a transparent glass substrate and various types of film formed in layers over an inner surface of the glass substrate. In the present embodiment, the liquid crystal layer 10C is made of a liquid crystal material whose dielectric anisotropy is negative, i.e. a negative-type liquid crystal material. Liquid crystal molecules contained in the negative-type liquid crystal material have the property to align themselves perpendicularly to electric lines of force present in electric fields. The sealing section 10D is made of a photo-curable resin material such as an ultraviolet-curable resin material, and is substantially in the shape of a frame that extends along outer peripheral ends of the CF substrate 10B (see FIG. 1). It should be noted that polarizing plates 10E are pasted to outer surfaces of the two substrates 10A and 10B, respectively.

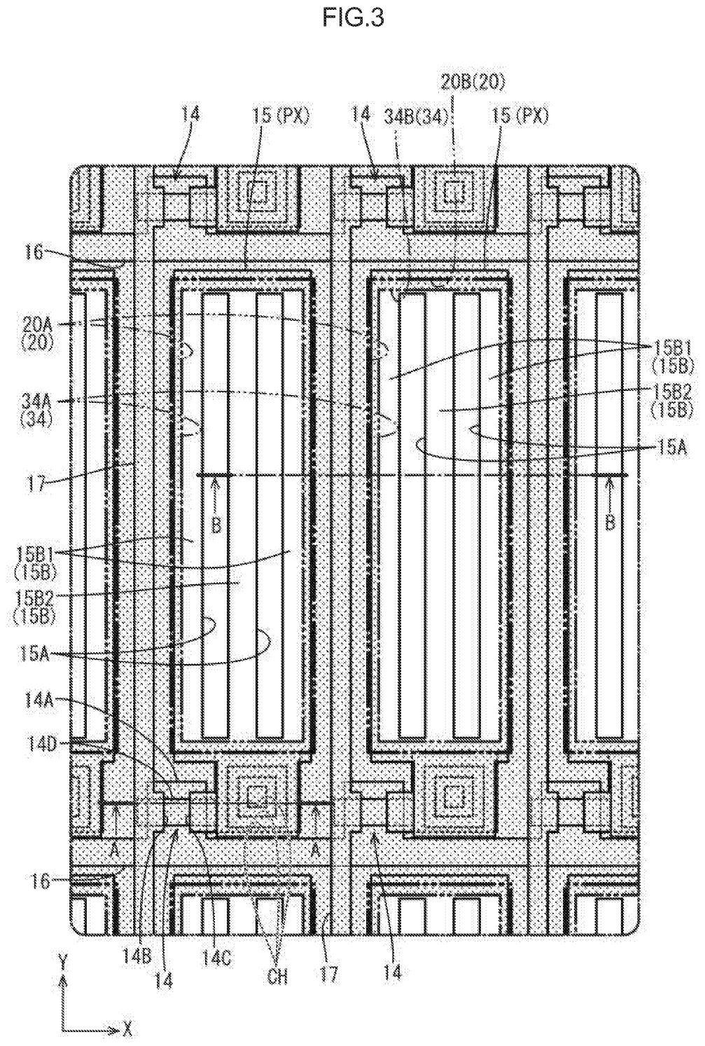

Over an inner surface of the array substrate 10A in the display region AA, as shown in FIG. 3, TFTs (thin-film transistors) 14 serving as switching elements and pixel electrodes 15 are arranged in a matrix (rows and columns). Around the TFTs 14 and the pixel electrodes 15, gate lines (scanning lines) 16 and source lines (data lines, signal lines) 17 formed in the shape of a arid are disposed to surround the TFTs 14 and the pixel electrodes 15. The gate lines 16 extend along the X-axis direction, and the source lines 17 extend along the Y-axis direction. The gate lines 16 and the source lines 17 are connected to gate electrodes 14A and source electrodes 14B of the TFTs 14, respectively, and the pixel electrodes 15 are connected to drain electrodes 14C of the TFTs 14, respectively. The pixel electrodes 15 are placed in regions surrounded by the pate lines 16 and the source lines 17 and form vertically long (longitudinally-shaped) squares. The pixel electrodes 15 have their long side direction corresponding to the Y-axis direction of each drawing and their short side direction corresponding to the X-axis direction of each drawing. Pluralities of the pixel electrodes 15 are arranged along the X-axis direction and the Y-axis direction together with the TFTs 14 to which they are connected. Each of the pixel electrodes 15 has a plurality of (in FIG. 3, two) slits 15A that extend along the long side direction (Y-axis direction.) thereof. Accordingly, the pixel electrode 15 is divided by the two slits 15A into three segmented electrodes 15B, and the segmented electrodes 15B and the slits 15A are alternately arranged along the X-axis direction (i.e. the short side direction of the pixel electrode 15). The following assumes that two of the three segmented electrodes 15B of the pixel electrode 15 that are located at both ends in the X-axis direction are end-side segmented electrodes 15B1 and of the three segmented electrodes 15B that is located on a center side in the X-axis direction is a center-side segmented electrode 15B2. The array substrate 10A has a substantially solid common electrode 18 formed in the display region AA in such a manner as to overlap the pixel electrodes 15. The common electrode 18 extends along the X-axis direction and the Y-axis direction in a plate surface of the array substrate 10A, has a range of formation over substantially the whole area of the display region AA, and is disposed to overlap all of the pixel electrodes 15 placed in the display region AA. That is, the liquid crystal panel 10 including the array substrate 10A according to the present embodiment operates in a mode called an FFS (fringe field switching) mode. Generation of a potential difference between the pixel electrodes 15 and the common electrode 18, which overlap each other, mainly causes horizontal electric fields to be generated between edges of the slits 15A in the pixel electrodes 15 and the common electrode 18, so that the orientation of the liquid crystal molecules contained in the liquid crystal layer 10C and the amount of light that is transmitted by the pixel electrodes 15 are controlled by the horizontal electric fields.

As shown in FIGS. 3 and 4, each of the TFTs 14 is located adjacent to a lower side, shown in FIG. 3 in the Y-axis direction, of a pixel electrode 15 to which it is connected. The gate electrode 14A of the TFT 14 is formed to branch off from a corresponding one of the gate lines 16 and protrude along the Y-axis direction. The source electrode 14B of the TFT 14 is composed of a part of a corresponding one of the source lines 17 and connected to one end of a channel region 14D. The drain electrode 14C of the TFT 14 is placed at a distance from the source electrode 14B in the X-axis direction, has end connected to the other end of the channel region 14D (opposite to the source electrode 14B), and has the other end connected to the pixel electrode 15. The channel region 14D of the TFT 14 overlaps gate electrode 14A, extend along the X-axis direction, and has both ends connected to the source electrode 14B and the drain electrode 14C, respectively. Moreover, when the TFT 14 is driven in accordance with a scanning signal supplied to the gate electrode 14A, an image signal (electric charge) supplied to the source line 17 is supplied from the source electrode 14B to the drain electrode 14C via the channel region 14D. As a result, the pixel electrode 15 is charged to a potential based on the image signal.

Meanwhile, over an inner surface of the CF substrate 10B in the display region AA, as shown in FIG. 5, at least a three-color color filter 19 placed in such a manner to overlap each pixel electrode 15, a light-blocking section (black matrix) 20 that partitions the color filter 19 into adjacent parts, and an overcoat film 21 are provided. The color filter 19 includes three colors, namely a red color filter 19R that exhibits a color of red and selectively transmits red light belonging to a red wavelength region (approximately 600 nm to approximately 780 nm), a blue color filter 19B that exhibits a color of blue and selectively transmits blue light belonging to a blue wavelength region (approximately 420 nm to approximately 500 nm), and a green color filter 19G that exhibits a color of green and selectively transmits green light belonging to a green wavelength region (approximately 500 nm to approximately 570 nm). The color filter 19 is an array in which sets of the red color filter 19R, the green color filter 19G, and the blue color filter 19B are repeatedly arranged along the X-axis direction. The color filter 19 is disposed to overlap each pixel electrode 15 on the side of the array substrate 10A in a plan view, and constitute pixels PX together with each pixel electrode 15. Pluralities of the pixels PX are arranged along the X-axis direction and the Y-axis direction in a plate surface of the liquid crystal panel 10. Each of the pixels PX includes a red pixel RPX that includes red color filter 19R and exhibits the color of red, a blue pixel BPX that includes the blue color filter 19B and exhibits the color of blue, and a green pixel GPX that includes the green color filter 19G and exhibits the color of green. One display pixel is constituted by a set of a red pixel RPX, a blue pixel BPX, and a green pixel GPX continuously arranged along the X-axis direction, and the display pixel performs a color display in accordance with a display tone of each of the colors of the pixels RTX, BPX, and GPX.

As shown in FIGS. 3 and 5, the light-blocking section 20 is in the shape of a grid in a plan view, and includes a first light-blocking section 20A that extends along the Y-axis direction and a second light-blocking section 20B that extends along the X-axis direction. It should be noted that in FIG. 3, the light-blocking section 20 has its edges illustrated by heavy chain double-dashed lines. The first light-blocking section 20A overlaps the source lines 17 in a plan view, partitions parts (pixels PX) of the color filter 19 that are adjacent to each other in the X-axis direction and exhibit different colors from each other, and blocks light from coming and going across these parts. That is, the first light-blocking section 20A makes difficult a mixture of colors of parts (pixels PX) of the color filter 19 that exhibit different colors. The second light-blocking section 20B overlaps the gate lines 16 in a plan view, partitions parts (pixels PX) of the color filter 19 that are adjacent to each other in the Y-axis direction and exhibit the same color, and blocks light from coming and going across these parts. That is, the second light-blocking section 20B suppresses a gradation shift that may occur in parts (pixels PX) of the color filter 19 that exhibit the same color. The overcoat film 21 is stacked on an inner surface of (at a higher level than) the color filter 19 as shown in FIG. 4, and has a function of planarizing the inner surface of the CF substrate 10B. Further, on inner surfaces of the two substrates 10A and 10B that face the liquid crystal layer 10C, alignment films 22 and 23 for anchoring the quid crystal molecules contained in the liquid crystal layer 10C are formed, respectively.

Further, on an outer surface of the CF substrate 10B, as shown in FIGS. 4 and 5, a conductive layer 24 for prevention of static charge is provided. In particular, as already mentioned, the liquid crystal panel 10 according to the present embodiment operates in a mode called an FFS mode, and is configured such that the pixel electrodes 15 and the common electrode 18 for applying electric fields to the liquid crystal layer 10C are placed on the side of the array substrate 10A and are not placed on the side of the CF substrate 10B. For this reason, the CF substrate 10B is more likely than the array substrate 10A to suffer from a display defect as a result of having its surface easily electrified (charged up) to store electric charges that have an effect of disrupting the orientation of the liquid crystal molecules contained in the liquid crystal layer 10C. To address this problem, the conductive layer 24 is stacked on the outer surface of the CF substrate 10B to be electrically connected to a around circuit via a predetermined connecting member. This allows the charges carried on the surface of the CF substrate 10B to be let out to the ground circuit. This makes it difficult for the surface to be electrified and makes it difficult to disrupt the orientation of the liquid crystal molecules contained in the liquid crystal layer 10C, thereby making it difficult for a display defect to be caused. The conductive layer 24 is constituted by a transparent electrode film solidly formed over substantially the whole area of the outer surface of the CF substrate 10B. The transparent electrode film that constitutes the conductive layer 24 is made of a transparent electrode material such as ITO.

Next, various types of film formed in layer over the inner surface of the array substrate 10A are described with reference to FIGS. 4 and 5. As shown in FIGS. 4 and 5, a first metal film (gate metal film) 25, a gate insulating film 26, a semiconductor film 27, a second metal film (source metal film) 28, a first interlayer insulating film 29, a planarizing film 30, a first transparent electrode film 31, a second interlayer insulating film 32, a second transparent electrode film 33, and the alignment film 22 are formed in layers over the array substrate 10A in this order from the bottom.

The first metal film 25 is a laminated film made by joining different types of metal material on top of each other or a single-layer film made of one type of metal material and, as shown in FIGS. 4 and 5, constitutes the gate lines 16, the gate electrodes 14A of the TFTs 14, and the like. The gate insulating film 26 is made of an inorganic insulating material (inorganic material) such as SiNₓ or SiO₂. The semiconductor film 27 is constituted by a thin film made of a material such as an oxide semiconductor, and constitutes the channel regions 14D of the TFTs 14 and the like. The second metal film 28 is a laminated film or a single-layer film as with the first metal film 25, and constitutes the source lines 17, the source electrodes 14B and drain electrodes 14C of the TFTs 14, and the like. The first interlayer insulating film 29 is made of an inorganic insulating material as with the gate insulating film 26. The planarizing film 30 is made of an organic insulating material (organic material) such as PMMA (acrylic resin), and is large in film thickness than the other insulating films 26, 29, and 32, each of which is made of an inorganic resin material. This planarizing film 30 causes the surface of the array substrate 10A to be planarized. The first transparent electrode film 31 is made of a transparent electrode material such as ITO as with the conductive layer 24 on the side of the CF substrate 10B, and constitutes the common electrode 18. The second interlayer insulating film 32 is made of an inorganic insulating material as with the gate insulating film 26 and the like. The second transparent electrode film 33 is made of a transparent electrode material as with the first transparent electrode film 31, and constitutes the pixel electrodes 15. That is, in the present embodiment, the pixel electrodes 15 are located closer to the liquid crystal layer 10C than the common electrode 18. The first interlayer insulating film 29, the planarizing film 30, and the second interlayer insulating film 32 have a contact hole CH bored therethrough so that a pixel electrode 15 constituted by the second transparent electrode film 33 is connected to a drain electrode 14C constituted by the second metal film 28. The contact hole CH is located in such a place as to overlap both the pixel electrode 15 and the drain electrode 14C in a plan view. The first interlayer insulating film 29, the planarizing film 30, and the second interlayer insulating film 32 are solidly formed at least over the whole area of the display region AA, excluding this contact hole CH.

Incidentally, as already mentioned, the lipoid crystal panel 10 according to the present embodiment is in the FFS mode, in which each pixel electrode 15 transmits a larger amount of light than in an IPS (in-plane switching) mode including a combtooth-shaped common electrode. On the other side, the FFS mode may cause the pixel electrodes 15 to be adjacent to each other at narrower spacings in the X-axis direction than in the IPS mode. In particular, the IPS mode, is which a part of the combtooth-shaped common electrode is interposed between the source lines and the pixel electrodes, allows the pixel electrodes to be adjacent to each other at wider spacings in the X-axis direction by the space in which to place the part of the common electrode. In the FFS mode, is which, as shown in FIG. 3, no space needs to be secured between the source lines 17 and the pixel electrodes 15 as in the case of the IFS mode, the pixel electrodes 15 are adjacent to each other at narrower spacings in the X-axis direction. For this reason, in the FFS mode, when the pixel electrodes 15 adjacent to each other in the X-axis direction are charged to different potentials from each other, stronger horizontal electric fields are more likely to be generated between those pixel electrodes 15 than in the IPS mode. Since such a horizontal electric field is generated near an end of a pixel electrode 15 in the X-axis direction, the orientation of liquid crystal molecules contained in the liquid crystal layer 10C that are present near the end is disrupted due to the horizontal electric field, with the result that gradation display of a pixel PX constituted by the pixel electrode 15 might be different from what it was originally expected to be. In particular, since ends of each pixel electrode 15 in the X-axis direction extend along the long side direction of the pixel electrode 15, stronger horizontal electric fields tend to be generated between ends in the X-axis direction of the pixel electrodes 15 adjacent to each other in the X-axis direction than at those ends in the Y-axis direction which extend along the short side direction of the pixel electrodes 15. For this reason, the orientation of the liquid crystal molecules contained in the liquid crystal layer 10C is easily disrupted due to a horizontal electric field, and a gradation display of the pixel PX easily shifts from what it was originally expected to be. Moreover, since the pixel electrodes 15 adjacent to each other in the X-axis direction constitute pixels PX that exhibit different colors from each other, a shift in gradation display causes an unintended color mixture. If than happens, a color display performed by a set of a red pixel RPX, a blue pixel BPX, and a green pixel GPX that constitutes one display pixel exhibits a tint differing from what it was originally expected to be. Furthermore, each of the pixel electrodes 15 has the slits 15A, bored therethrough, that extend along the long side direction thereof, so that there is a parallel relationship between horizontal electric fields generated between edges of the slits 15A of the pixel electrode 15 and the common electrode 18 and horizontal electric fields generated between the pixel electrodes 15 adjacent to each other in the X-axis direction. For this reason, if horizontal electric fields are generated between the pixel electrodes 15 adjacent to each other in the X-axis direction, the orientation of the liquid crystal molecules contained in the liquid crystal layer 10C tends to be more easily disrupted due to the horizontal electric fields.

To address this problem, as shown in FIGS. 3 and 5, a counter electrode 34 is provided over the inner surface of the CF substrate 10B according to the present embodiment in the display region AA in order to reduce horizontal electric fields generated between the pixel electrodes 15 adjacent to each other in the X-axis direction. It should be noted that in FIG. 3, the counter electrode 34 has its edges illustrated by thin chain double-dashed lines and its range of formation illustrated by half-tone dot meshing. The counter electrode 34 is stacked at a higher level than the overcoat film 21 and at a lower level than the alignment film 23. The counter electrode 34 is constituted by a transparent electrode film such as ITO as with the pixel electrodes 15 and the common electrode 18 on the side of the array substrate 10A. The counter electrode 34 is located in places between parts of the color filter 19 adjacent to each other in the X-axis direction and the Y-axis direction. in the CF substrate 10B, and is in the shape of a grid as a whole. That is, the counter electrode 34 is placed so that a large part thereof overlaps the light-blocking section 20 in a plan view. The counter electrode 34 is located in places between the pixel electrodes 15 adjacent to each other in the X-axis direction and the Y-axis direction in the array substrate 10A, and overlaps the gate lines 16 and the source lines 17 in a plan view.

In particular, as shown in FIG. 3, the counter electrode 34 includes a first electrode section 34A that extends along the Y-axis direction (i.e. the long side direction of the pixel electrodes 15) and a second electrode section 34B that extends along the X-axis direction (i.e. the short side direction of the pixel electrodes 15). The first electrode section 34A overlaps the first light-blocking section 20A and the source lines 17 in a plan view, and is placed between pixels PX (i.e. the pixel electrodes 15 and the color filter 19) adjacent to each other in the X-axis direction that exhibit different colors from each other. The second electrode section 34B overlaps the second light-blocking section 20B and the gate lines 16 in a plan view, and is placed between pixels PX (i.e. the pixel electrodes 15 and the color filter 19) adjacent to each other in the Y-axis direction that exhibit the same color. While a large part of the counter electrode 34 is placed in the display region AA, the counter electrode 34 has a part extended toward the non-display region NAA, and the extended part is disposed to overlap the sealing section 10D (see FIG. 1) in a plan view. Meanwhile, the array substrate 10A s provided with a reference potential line, connected to the common electrode 18, that supplies a constant reference potential to the common electrode 18 and a conductive pad section connected to the reference potential line. This conductive pad section is located in a place that overlaps the sealing section 10D and the extended part of the counter electrode 34 in a plan view, and is conductively connected to the extended part of the counter electrode 34 via conducting particles contained in the sealing section 10D. This allows the counter electrode 34 to be supplied with the same reference potential as the common electrode 18. That is, the counter electrode 34 is constantly kept at the same potential as the common electrode 18. It should be noted that the reference potential line and the conductive pad section are constituted by either or both of the first and second metal films 25 and 28.

Moreover, as shown in FIG. 5, the first electrode section 34A of the counter electrode 34 that extends along the Y-axis direction is wider than the spacing between the pixel electrodes 15 adjacent to each other in the X-axis direction, and is disposed to selectively overlap ends in the X-axis direction of the pixel electrodes 15 adjacent to each other in the X-axis direction. That is, the first electrode section 34A of the counter electrode 34 has a width of formation astride the pixel electrodes 15 adjacent to each other in the X-axis direction, and both ends of the first electrode section 34A in a width direction (X-axis direction) thereof overlap ends of the pixel electrodes 15, respectively. Ranges of overlap (widths of overlap) between the first electrode section 34A and two pixel electrodes 15 adjacent to each other in the X-axis direction are equal to each other. This causes vertical electric fields be selectively generated between those ends in the X-axis direction of the pixel electrodes 15 adjacent to each other in the X-axis direction which overlap the first electrode section 34A end first electrode section 34A. These generation of these vertical electric fields efficiently reduces strong horizontal electric fields generated between those ends of the pixel electrodes 15 adjacent to each other in the X-axis direction which extend along the Y-axis direction. This makes it difficult for such a situation to arise that the orientation of liquid crystal molecules contained in the liquid crystal layer 10C near ends of the pixel electrodes 15 in the X-axis direction is disrupted due to the aforementioned horizontal electric fields, making it highly probable that originally-expected gradation display is performed in the pixel electrodes 15 adjacent to each other in the X-axis direction. The optimization of display tones of pixels PX, constituted by the pixel electrodes 15 adjacent to each other in the X-axis direction, that exhibit different colors from each other makes appropriate the tint of a color cis lay performed by a display pixel composed of pixels RPX, BMX, and GPX three colors, resulting in high display quality.

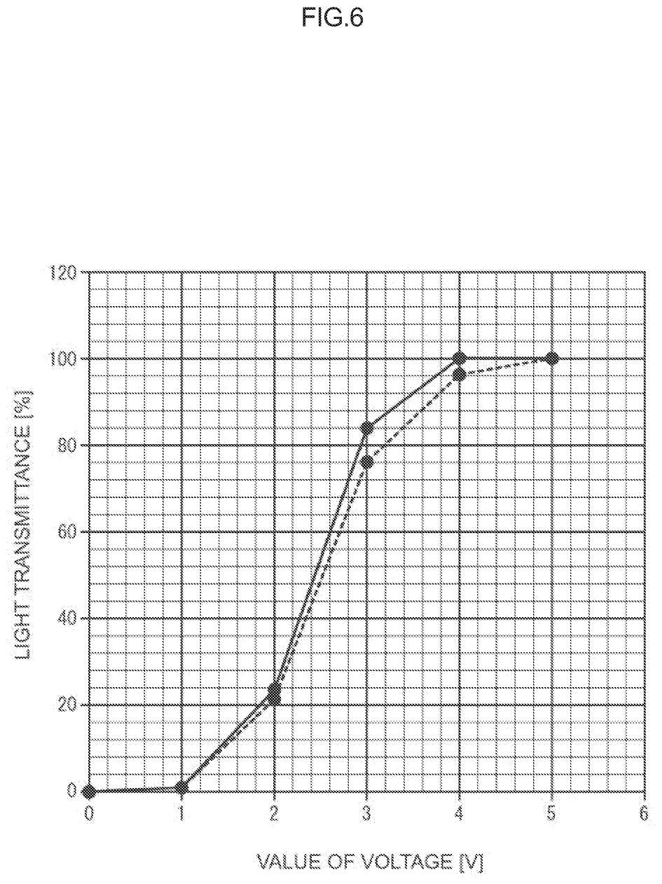

More specifically, as shown in FIGS. 3 and 5, the first electrode section 34A of the counter electrode 34 overlaps parts (end-side parts) of the end-side segmented electrodes 15B1 of each pixel electrode 15 but is disposed not to overlap the remaining parts (center-side parts) of the end-side segmented electrodes 15B1 and the center-side segmented electrodes 15B2. Since, as just described, each pixel electrode 15 is not placed so that the whole area thereof overlaps the counter electrode 34 but has a part (including the center-side segmented electrodes 15B2) that does not overlap the counter electrode 34, a horizontal electric field generated between that part and the common electrode 18 avoids being reduced by vertical electric fields generated between those parts of the side segmented electrodes 15B1 of each pixel electrode 15 which overlap the counter electrode 34 and the first electrode section 34A. This makes it easy to control, through a potential that is applied to each pixel electrode 15, the orientation of the liquid crystal molecules contained in the liquid crystal layer 10C, thus achieving suitability for reduction in power consumption. These workings and effects are specifically described with reference to FIG. 6. FIG. 6 shows a graph whose horizontal axis represents the value of voltage (whose unit is “V”) applied to a pixel electrode 15 and vertical axis represents the light transmittance (whose unit, is “%”) of the pixel electrode 15 (pixel PX). In FIG. 6, the dashed-line graph represents a case (Comparative Example 1) where a solid counter electrode is placed over the whole area of the display region AA at a higher level than the overcoat film 21 in the CF substrate 10B, and the solid-line graph represents a case (Comparative Example 2) where a counter electrode such as that of Comparative Example 1 is not placed. It should be noted that Comparative Examples 1 and 2 are identical in configuration to the FES mode liquid crystal panel 10 described before the present paragraph, except for the presence or absence of the solid counter electrode described above. Comparative Example 1, in which a solid counter electrode is placed, is equal in value of voltage of the pixel electrode 15 to but lower in light transmittance of the pixel electrode 15 than Comparative Example 2, in which a solid counter electrode is not placed. A conceivable reason for that is that in Comparative Example 1, a vertical electric field is generated between the whole area of the pixel electrode 15 and the solid counter electrode and the vertical electric field reduces an originally-needed horizontal electric field generated between the pixel electrode 15 and the common electrode 18 and makes it difficult to control the orientation of the liquid crystal molecules contained in the liquid crystal layer 10C. Comparative Example 2, which does not have a solid counter electrode such as that of Comparative Example 1, can be said to tend to be high in light transmittance of the pixel electrode 15, as it does not reduce a horizontal electric field generated between the pixel electrode 15 and the common electrode 18 and makes it easy to control the orientation of the liquid crystal molecules contained in the liquid crystal layer 10C. Moreover, the counter electrode 34 according to the present embodiment is disposed not to overlap the center-side segmented electrode 15B2 or the like of the pixel electrode 15; therefore, as in Comparative Example 2, it is difficult to reduce a horizontal electric field generated between a part (including the center-side segmented electrodes 15B2) of the pixel electrode 15 that does not overlap the counter electrode 34 and the common electrode 18. This causes the present embodiment to be equal in value of voltage of the pixel electrode 15 to but higher in light transmittance of the pixel electrode 15 than Comparative Example 1.

In addition, as shown in FIGS. 3 and 5, the first electrode section 34A of the counter electrode 34 is wider in width than the first light-blocking section 20A of the light-blocking section 20. That is, the first light-blocking section 20A is narrower in width than the first electrode section 34A. In addition, the first light-blocking section 20A is disposed not to overlap the pixel electrodes 15 adjacent to each other in the X-axis direction. This makes it difficult for the first light-blocking section 20A to block light transmitted by the pixel electrodes 15 adjacent to each other in the X-axis direction, thus bringing about improvement in aperture ratio.

Further, as shown in FIGS. 3 and 5, the first electrode section 34A of the counter electrode 34 is disposed to overlap the source lines 17. In the array substrate 10A, the source lines 17 are covered with the common electrode 18 located thereabove. However, there is a case where a partial opening is formed in this common electrode 18. In that case, vertical electric fields are generated between the source lines 17 and the counter electrode 34. These vertical electric fields make it possible to reduce horizontal electric fields generated between the source lines 17 and the pixel electrodes 15, thus making it difficult for the orientation of the liquid crystal molecules contained in the liquid crystal layer 10C to be disrupted due to the potentials of the source lines 17. This optimizes gradation displays of the pixel electrodes 15. Further, as shown in FIG. 3, the second electrode section 34B of the counter electrode 34 is disposed to overlap the gate lines 16. In the array substrate 10A, the gate lines 16 are covered with the common electrode 18 located thereabove. However, there is a case where a partial opening is formed in this common electrode 18. In that case, vertical electric fields are generated between the gate lines and the counter electrode 34. These vertical electric fields make it possible reduce horizontal electric fields generated between the gate lines 16 and the pixel electrodes 15, thus making it difficult for the orientation of the liquid crystal molecules contained in the liquid crystal layer 10C to be disrupted due to the potentials of the gate lines 16. This optimizes gradation displays of the pixel electrodes 15. It should be noted that there is a case where the opening of the common electrode 18 is intentionally formed by a designer or may formed despite the designer's intensions, but in either case, the counter electrode 34 disposed to overlap the gate lines 16 and the source lines 17 makes it possible to inhibit the orientation of liquid crystal molecules from being disrupted due to electric fields generated from the gate lines 16 and the source lines 17.

As described above, a liquid crystal panel 10 of the present embodiment includes: an array substrate (first substrate) 10A having a plurality of pixel electrodes 15, arranged along a short side direction thereof, that have longitudinal shapes and a common electrode 18 disposed to overlap the plurality of pixel electrodes 15; a CF substrate (second substrate) 10B, placed opposite the array substrate 10A, that has a counter electrode 34 disposed to extend along a long side direction of the pixel electrodes 15, be wider in width than a spacing between the pixel electrodes 15 adjacent to each other in the short side direction, and selectively overlap ends in the short side direction of the pixel electrodes 15 adjacent to each other in at least the short side direction; and a liquid crystal layer 10C sandwiched between the array substrate 10A and the CF substrate 10B.

In this way, charging of the plurality of pixel electrodes 15 in the array substrate 10A causes horizontal electric fields to be generated between the plurality of pixel electrodes 15 and the common electrode 18. On the basis of these horizontal electric fields, the orientation of liquid crystal molecules contained in the liquid crystal layer 10C sandwiched between the array substrate 10A and the CF substrate 10B is controlled, so that he amount of transmitted light is controlled for each pixel electrode 15. The CF substrate 10B placed opposite the array substrate 10A has the counter electrode 34. Since this counter electrode 34 is disposed to extend along the long side direction of the pixel electrodes 15, be wider in width than a spacing between the pixel electrodes 15 adjacent to each other in the short side direction, and selectively overlap the ends in the short side direction of the pixel electrodes 15 adjacent to each other in at least the short side direction, vertical electric fields are selectively generated between those ends of each pixel electrode 15 in the short side direction which overlap the counter electrode 34 and the counter electrode 34. The generation of these vertical electric fields entails a reduction of horizontal electric fields that are generated between those ends of the pixel electrodes 15 adjacent to each other in the short side direction which extend along the long side direction. In particular, since ends of each of the pixel electrodes 15 in the short side direction extend along the long side direction, stronger horizontal electric fields tend to be generated between ends in the short side direction of the pixel electrodes 15 adjacent to each other than at those ends in the long side direction which extend along the short side direction. Accordingly, an efficient reduction of horizontal electric fields can be achieved by vertical electric fields generated by putting he counter electrode 34 on top of ends in the short side direction of the pixel electrodes 15 adjacent to each other. This makes it difficult for such a situation to arise that the orientation of liquid crystal molecules contained in the liquid crystal layer 10C is disrupted due to the aforementioned horizontal electric fields, making it highly probable that an originally-expected gradation display is performed in the pixel electrodes 15 adjacent to each other in the short side direction. Further, the counter electrode 34, which selectively overlaps the ends in the short side direction of the pixel electrodes 15 adjacent to each other in at least the short side direction, is not configured to overlap the whole area of each pixel electrode 15. That is, since each pixel electrode 15 has a part that does not overlap the counter electrode 34, horizontal electric field generated between that part and the common electrode 18 avoids being reduced by a vertical electric field generated between a part of each pixel electrode 15 that overlaps the counter electrode 34 and the counter electrode 34. This makes it easy to control, through a potential that is applied to each pixel electrode 15, the orientation of the liquid crystal molecules contained in the liquid crystal layer 10C, thus achieving suitability for reduction in power consumption.

Further, the common electrode 18 extends along at least the short side direction astride the pixel electrodes 15 adjacent to each other in at least the short side direction. This brings about a so-called FFS (fringe field switching) mode, in which each pixel electrode 15 transmits a larger amount of light than in an IPS (in-plane switching) mode including a combtooth-shaped common electrode 18. On the other side, the FFS mode may cause the pixel electrodes 15 to be adjacent to each other at narrower spacings in the short side direction than the IPS mode, so that stronger horizontal electric fields tend to be generated between those pixel electrodes 15. In contrast to this, by being disposed to overlap the ends in the short side direction of the pixel electrodes 15 adjacent to each other in at least the short side direction, the counter electrode 34 causes vertical electric fields to be generated between those pixel electrodes 15, and the vertical electric fields make it possible to achieve an efficient reduction of horizontal electric fields that are generated between the pixel electrodes 15 adjacent to each other.

Further, the CF substrate 10B has a color filter 19 having a plurality of parts, arranged along the short side direction and disposed to overlap the plurality of pixel electrodes 15, that exhibit different colors. In this way, the plurality of pixel electrodes 15 arranged along the short side direction in the array substrate 10A and the plurality of color filters 19 arranged along the short side direction in the CF substrate 10B overlap each other, and lights whose amounts of transmission through the liquid crystal layer 10C may be controlled according to the potential of each separate pixel electrode 15 exhibit different colors from each other by being transmitted through each separate color filter 19. Note here that if the orientation of the liquid crystal molecules contained in the liquid crystal layer 10C is disrupted by generation of horizontal electric fields between the pixel electrodes 15 adjacent to each other in the short side direction, color filters 19 adjacent to each other in the short side direction perform gradation displays different from what they are originally expected to be, so that an unintended color mixture might occur. In that respect, since the counter electrode 34 achieves a reduction of horizontal electric fields that are generated between the pixel electrodes 15 adjacent to each other in the short side direction, it becomes difficult for such a situation to arise that the orientation of the liquid crystal molecules contained in the liquid crystal layer 10C is disrupted, so that the color filters 19 adjacent to each other in the short side direction perform optimized gradation displays. This inhibits the occurrence of an unintended color mixture.

Further, the CF substrate 10B has a light-blocking section 20 placed so that at least a part thereof overlaps the counter electrode 34 and does not overlap the pixel electrodes 15 adjacent to each other in the short side direction. In this way, the light-blocking section 20 makes it possible to block light from coming and going across the pixel electrodes 15 adjacent to each other in the short side direction. The light-blocking section 20, which does not overlap the pixel electrodes 15 adjacent to each other in the short side direction, is narrower in width than the counter electrode 34, which overlaps the pixel electrodes 15 adjacent to each other is the short side direction, thus suitably bringing about improvement in aperture ratio.

Further, the pixel electrodes 15 are located closer to the liquid crystal layer 10C than the common electrode 18. In this way, the liquid crystal molecules contained in the liquid crystal layer 10C are more strongly effected by horizontal electric fields generated between the pixel electrodes 15 adjacent to each other in the short side direction than if a common electrode is located closer to the liquid crystal layer 10C than pixel electrodes. In that respect, since the counter electrode 34 achieves a reduction of horizontal electric fields that are generated between the pixel electrodes 15 adjacent to each other in the short side direction, disruption of the orientation of the liquid crystal molecules due to horizontal electric fields is effectively inhibited.

Further, each of the pixel electrodes 15 has a slit 15A, bored therethrough, that extends along the long side direction. In this way, the orientation of the liquid crystal molecules contained in the liquid crystal layer 10C is controlled by a horizontal electric field generated between an edge of the slit 15A in the pixel electrode 15 and the common electrode 18. Since this slit 15A extends along the long side direction of the pixel electrode 15, a horizontal electric field generated between the edge of the slits 15A in the pixel electrode 15 and the common electrode 18 and a horizontal electric field generated between pixel electrodes 15 adjacent to each other in the short side direction are in such a relationship as to be parallel to each other. For this reason, the orientation of the liquid crystal molecules contained in the liquid crystal layer 10C tends to be more easily disrupted due to a horizontal electric field generated between pixel electrodes 15 adjacent to each other in the short side direction. In that respect, since the counter electrode 34 achieves a reduction of horizontal electric fields that are generated between the pixel electrodes 15 adjacent to each other in the short side direction, it becomes difficult for such a situation to arise that the orientation of the liquid crystal molecules contained in the liquid crystal layer 10C is disrupted, that it becomes highly probable that an originally-expected gradation display is performed in the pixel electrodes 15 adjacent to each other in the short side direction.

Further, each of the pixel electrodes 15 has a plurality of the slits 15A formed at spacings in the short side direction and at least three segmented electrodes 15B disposed in such a manner as to be arranged alternately with the slits 15A, and the counter electrode 34 is disposed to overlap end side segmented electrodes 15B1 that are segmented electrodes 15B placed at ends in the short side direction but not to overlap a center-side segmented electrode 15B2 that is a segmented electrode 15B placed on a center side in the short side direction. In this way, since the center-side segmented electrode 15B2 of the pixel electrode 15 placed on the center side in the short side direction does not overlap the counter electrode 34, a horizontal electric field generated between the center-side segmented electrode 15B2 and the common electrode 18 avoids being reduced by vertical electric fields generated between the end-side segmented electrodes 15B1 of the pixel electrode 15, placed at the ends in the short side direction, that overlap the counter electrode 34 and the counter electrode 34.

Further, the counter electrode 34 is equal in potential to the common electrode 18. In this way, a potential difference between the counter electrode 34 and the pixel electrodes 15 becomes greater than if a potential that is applied to the counter electrode is closer to the potentials of the pixel electrodes 15 than to the potential of the common electrode 18. This causes sufficiently strong vertical electric fields to be generated between the counter electrode 34 and the pixel electrodes 15, making it possible to suitably reduce horizontal electric fields generated between the pixel electrodes 15 adjacent to each other in the short side direction.

Further, the liquid crystal layer 10C is made of a liquid crystal material whose dielectric anisotropy is negative. In this way, the liquid crystal molecules contained in the liquid crystal layer 10C align themselves perpendicularly to electric lines of force present in electric fields. Accordingly, liquid crystal molecules aligned perpendicularly to electric lines of force present in vertical electric fields generated between the counter electrode 34 and the pixel electrodes 15 become horizontally aligned. This makes it difficult for the placement of the counter electrode 34 to adversely affect the orientation of the liquid crystal molecules contained in the liquid crystal layer 10C.

### Embodiment 2

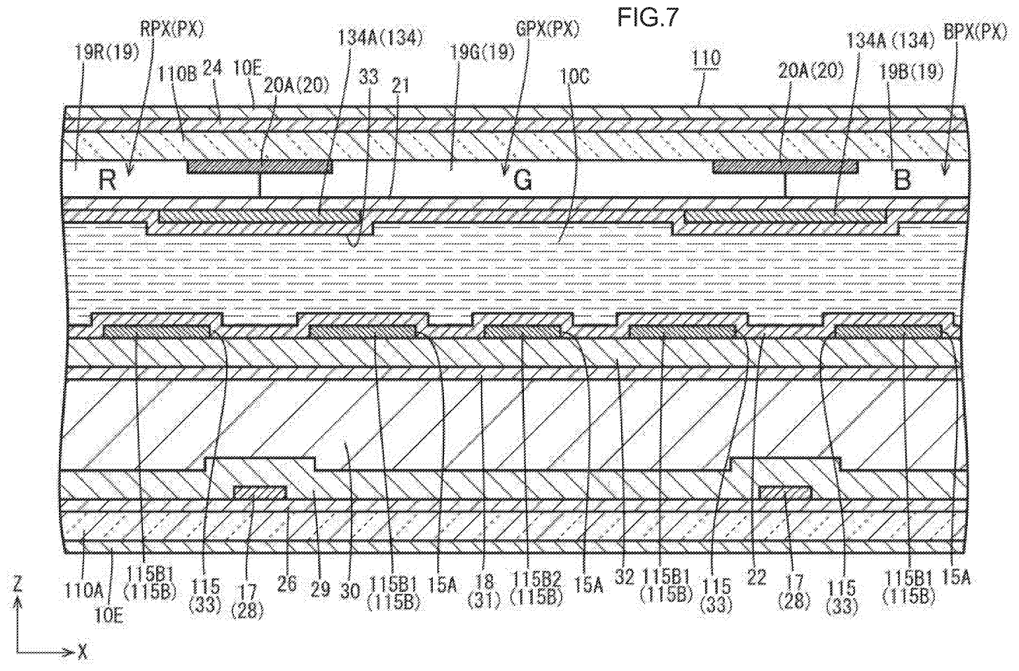

Embodiment 2 will be described with reference to FIG. 7. Embodiment 2 illustrates changes made to achieve a configuration of pixel electrodes 115. It should be noted that a repeated description of structures, workings, and effects that are similar to those of Embodiment 1 described above is omitted.

As shown in FIG. 7, the pixel electrode 115 according to the present embodiment is formed so that end-side segmented electrodes 115B1 are wider in width than a center-side segmented electrode 115B2. Meanwhile, a first electrode section 134A of a counter electrode 134 is equal in width dimension to Embodiment 1 described above. Accordingly, the end-side segmented electrodes 115B1 are identical in range of overlap with the first electrode section 134A to Embodiment 1 described above, but are wider in range of non-overlap with the first electrode section 134A than Embodiment 1 described above. This makes it highly probable that the first electrode section 134A is disposed to overlap the pixel electrode 115, even in a case where misregistration between two substrates 110A and 110B in the X-axis direction leads to misregistration of the first electrode section 134A with respect to the pixel electrode 115 in the step of bonding the two substrates 110A and 110B together in the process of manufacturing a liquid crystal panel 110. In other words, a margin of misregistration between the two substrates 110A and 110B in the X-axis direction becomes larger as much as the end-side segmented electrodes 115B1 have become wider in width than the center-side segmented electrode 115B2.

As described above, according to the present embodiment, each of the pixel electrodes 115 is formed so that the end-side segmented electrodes 115B1, which are the segmented electrodes 115E placed at the ends in the short side direction, are wider in width than the center-side segmented electrode 115B2, which is the segmented electrode 115B placed on the center side in the short side direction. In placing the array substrate 110A and the CF substrate 110B opposite each other, misregistration might occur between the two substrates 110A and 110B. The occurrence of such misregistration may lead to a variation in positional relationship between the pixel electrodes 115 of the array substrate 110A and the counter electrode 134 of the CF substrate 110B. In that respect, the end-side segmented electrodes 115B1 of the pixel electrode 115, placed at the ends in the short side direction, that overlap the counter electrode 134 are wider in width than the center-side segmented electrode 115B2, placed on the center side in the short side direction, that does not overlap the counter electrode 134; therefore, even in the case of misregistration between the two substrates 110A and 110B in the short side direction, the counter electrode 134 is highly probably disposed to overlap the end-side segmented electrodes 115B1 placed at the ends in the short side direction. In other words, a margin of misregistration between the two substrates 110A and 110B in the short side direction becomes larger as much as the end-side segmented electrodes 115E1 placed at the ends in the short side direction have become wider in width than the center-side segmented electrode 115B2 placed on the center side.

### Embodiment 3

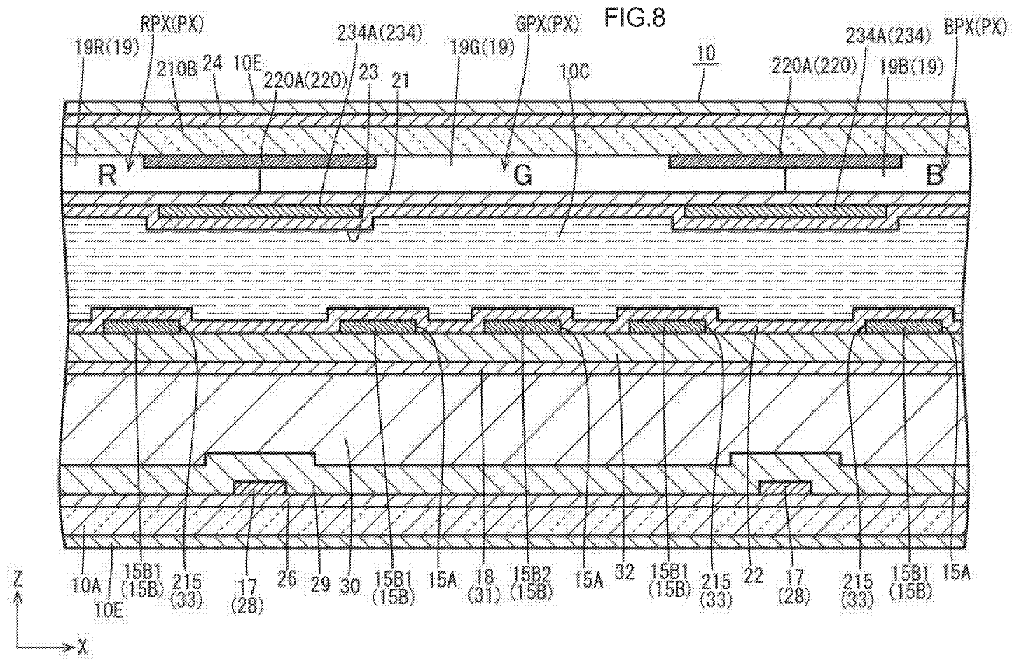

Embodiment 3 will be described with reference to FIG. 8. Embodiment 3 illustrates changes made to Embodiment 1 to achieve a configuration of a light-blocking section 220. It should be noted that a repeated description of structures, workings, and effects that are similar to those of Embodiment 1 described above is omitted.

As shown in FIG. 8, the light-blocking section 220 according to the present embodiment is formed so that a first light-blocking section 220A overlaps ends of pixel electrodes 215 in the X-axis direction. In particular, the first light-blocking section 220A is winder in width dimension than the spacing between pixel electrodes 215 adjacent to each other in the X-axis direction. In addition, the first light blocking section 220A is wider in width than a first electrode section 234A of a counter electrode 234. That is, the first light-blocking section 220A is wider in range of overlap with the pixel electrodes 215 than the first electrode section 234A. This makes it possible to, even if scattering of light occurs near an end of the first electrode section 234A in the X-axis direction, block the light with the first light-blocking section 220A, which is wider in width than the first electrode section 234A and wider in range of overlap with the pixel electrodes 215 than the first electrode section 234A. This suppresses a reduction in contract due to scattering light.

As described above, according to the present embodiment, the substrate 210B has a light-blocking section 220 at least a part of which overlaps the counter electrode 234 and overlaps ends in the short side direction of the pixel electrodes 215 adjacent to each other in the short side direction, and the light-blocking section 220 has a wider range of overlap with the pixel electrodes 215 than a range of overlap between the counter electrode 234 and the pixel electrodes 215. In this way, the light-blocking section 220 makes it possible to block light from coming and going across the pixel electrodes 215 adjacent to each other in the short side direction. Even if scattering of light occurs near an end of the counter electrode 234 in the short side direction, the light can be blocked by the light-blocking section 220, which is wider in range of overlap with the pixel electrodes 215 than the counter electrode 234. This suppresses a reduction in contract due to scattering light.

### Embodiment 4

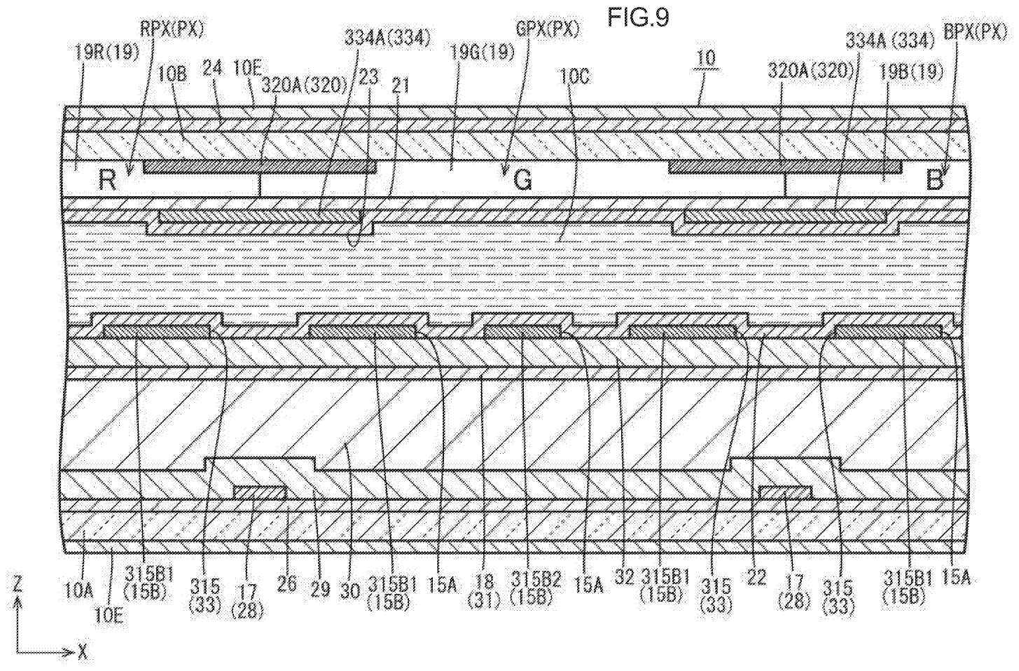

Embodiment 4 will be described with reference to FIG. 9. Embodiment 4 illustrates a combination of the configuration of Embodiment 2 described above and configuration of Embodiment 3. should be noted that a repeated description of workings and effects that are similar to those of Embodiments 2 and 3 described above is omitted.

As shown in FIG. 9, a pixel electrode 315 according to the present embodiment is formed so that end-side segmented electrodes are wider in width than a center-side segmented electrode 315B2. Meanwhile, a first light-blocking section 320A of a light-blocking section 320 according to the present embodiment is wider in width than a first electrode section 334A of a counter electrode 334, and a range of overlap of the first light-blocking section 320A with respect to the end-side segmented electrodes 315B1 of the pixel electrode 315 is wider than a range of overlap of the first electrode section 334A with respect to the end-side segmented electrodes 315B1.

### Embodiment 5

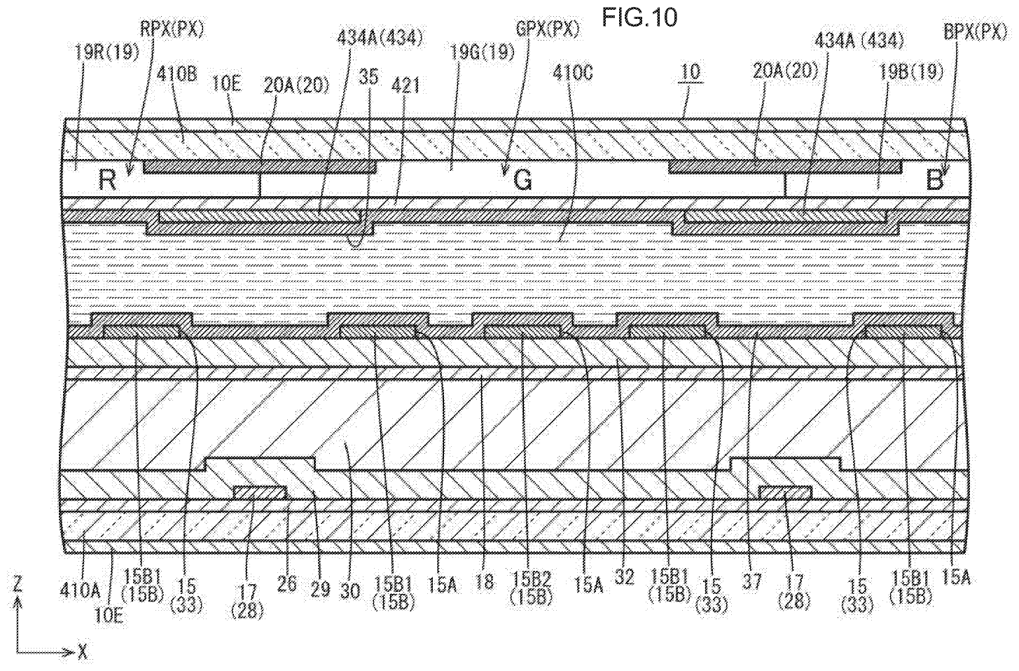

Embodiment 5 will be described with reference to FIG. 10. Embodiment 5 illustrates changes made to Embodiment 3 to achieve an alignment film. It should be noted that a repeated description structures, workings, and effects that are similar to those of Embodiment 3 described above is omitted.

As shown in FIG. 10, a CF substrate 410B according to the present embodiment is configured such that a low-resistance alignment film 35 is provided on an inner surface facing a liquid crystal layer 410C. The low-resistance alignment film 35 has a specific resistance value (volume resistivity) of specifically for example approximately 10¹⁰ to 10¹⁴ Ωcm that is lower than that of the alignment films 22 and 23 described in Embodiment 1 described above. The low-resistance alignment film 35 may be formed, for example, by imidization of polyimide acid or polyamide acid ester. This low-resistance alignment film 35 is solidly formed over the whole area of at least a display region while covering a counter electrode 434 and an overcoat 421. The low-resistance alignment 35 thus configured makes electrical connections between a plurality of first electrode sections 434A of the counter electrode 434 and between a plurality of second electrode sections. Accordingly, even in a case where the CF substrate 410B gets its surface electrified, the electric charges carried on the surface of the CF substrate 410B can be let out by the low-resistance alignment film 35 and the counter electrode 434. This makes it possible to inhibit the occurrence of a display defect that is entailed by the electrification of the substrate 410B. In the present embodiment, the placement of the low-resistance alignment film 35 entails removal of a conductive layer (see FIG. 5) placed on an outer surface of the CF substrate 410B in Embodiment 1. This makes it possible to omit the step of forming a conductive layer in manufacturing the CF substrate 410B or other steps, thus making it possible to achieve a reduction in manufacturing cost of the CF substrate 410B. It should be noted that a low-resistance alignment film 37 which is similar to that on the side of the CF substrate 410B is formed on an inner surface of an array substrate 410A that faces the liquid crystal layer 410C. For a reduction in manufacturing cost, is preferable that the low-resistance alignment films 35 and 37 be made of the same material on the side of the array substrate 410A and on the side of the CF substrate 410B.

As described above, according to the present embodiment, the CF substrate 410B has a low-resistance alignment film 35, disposed to overlap a side of the counter electrode 434 that faces the liquid crystal layer 410C, that extends along at least the short side direction. Since the low-resistance alignment film 35 overlaps the counter electrode 434 and extends along at least the short side direction, the surface of the CF substrate 410B can be inhibited from being electrified (charged up). Since the low-resistance alignment film 35 suppresses electrification, there is no need to form an antistatic conductive layer on the surface of the CF substrate 410B opposite to the liquid crystal layer 410C.

### Embodiment 6

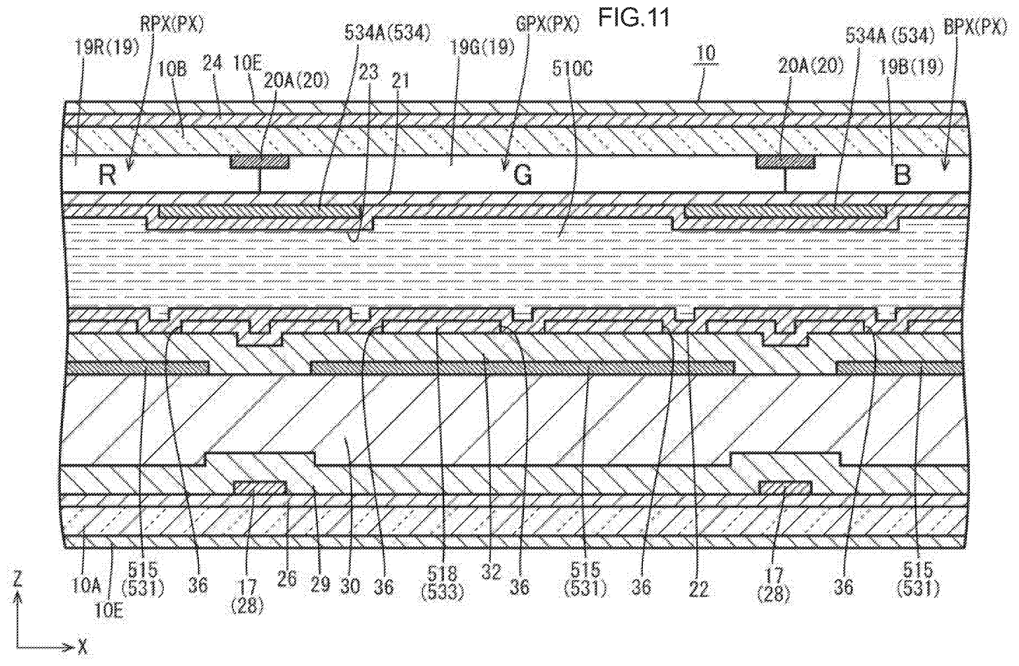

Embodiment 6 will be described with reference to FIG. 11. Embodiment 6 illustrates changes made to Embodiment 1 to achieve a configuration of pixel electrodes 515 and a common electrode 518. It should be noted that a repeated description of structures, workings, and effects that are similar to those of Embodiment 1 described above is omitted.

As shown in FIG. 11, the pixel electrodes 515 according to the present embodiment are constituted by first transparent electrode film 531, whereas the common electrode 518 is constituted by a second transparent electrode film 533. That the common electrode 518 is located closer to a liquid crystal layer 510C than the pixel electrodes 515. With such a configuration, the liquid crystal molecules contained in the liquid crystal layer 510C are less affected by horizontal electric fields generated between the pixel electrodes 515 adjacent to each other in the X-axis direction than in Embodiment 1 described above. That is, since this structure makes it difficult for the orientation of the liquid crystal molecules to be disrupted due to horizontal electric fields intrinsically generated between the pixel electrodes 515 adjacent to each other in the X-axis direction, a counter electrode 534 makes it possible to make it more difficult to disrupt the orientation of the liquid crystal molecules.

In particular, the pixel electrodes 515 do not have formed therein slits (see FIG. 5) such as those described in Embodiment 1 described above. Meanwhile, the common electrode 518 has slits 36, bored therethrough, that extend along the Y-axis direction (i.e. the long side direction of the pixel electrode 515) The slits 36 include a plurality of (in the present embodiment, for example, three) slits 36 provided in a part (pixel electrode overlapping part) of the solid common electrode 518 that overlaps each pixel electrode 515. Charging of the pixel electrodes 515 mainly causes horizontal electric fields to be generated between the pixel electrodes 515 and edges of the slits 36 in the common electrode 518, so that the orientation of the liquid crystal molecules contained in the liquid crystal layer 510C and the amount of light that is transmitted by the pixel electrodes 515 are controlled by the horizontal electric fields. Moreover, a counter electrode 534 is placed so that ends thereof in the X-axis direction (i.e. one short side direction of the pixel electrodes 515) overlap the slits 36. In particular, each end of a first electrode section 534A of the counter electrode 534 in the X-axis direction is disposed to overlap each slit 36, located at an end in the X-axis direction, of the three slits 36 placed in a part of the common electrode 518 that overlaps each pixel electrode 515. This causes vertical electric fields to be favorably generated through the slits 36 of the common electrode 518 between ends of the first electrode section 534A in the X-axis direction and the pixel electrodes 515. These vertical electric fields make it possible to suitably reduce horizontal electric fields generated between pixel electrodes 515 adjacent to each other in the X-axis direction.

As described above, according to the present embodiment, the common electrode 518 is located closer to the liquid crystal layer 510C than the pixel electrodes 515. In this way, the liquid crystal molecules contained in the liquid crystal layer 510C are less affected by horizontal electric fields generated between the pixel electrodes 515 adjacent to each other in the short side direction than if pixel electrodes are located closer to liquid crystal layer 510C than a common electrode. That is, since this structure makes it difficult for the orientation of the liquid crystal molecules to be disrupted due to horizontal electric fields intrinsically generated between the pixel electrodes 515 adjacent to each other in the short side direction, the counter electrode 534 makes it possible to make it more difficult to disrupt the orientation of the liquid crystal molecules.

Further, the common electrode 518 has a slit 36, bored therethrough, that extends along the long side direction, and the counter electrode 534 is placed so that an end thereof in the short side direction overlaps the slit 36. In this way, the orientation of the liquid crystal molecules contained in the liquid crystal layer 510C is controlled by horizontal electric fields generated between edges of the slit 36 in the common electrode 518 and the pixel electrodes 515. Since the counter electrode 534 is placed so that ends thereof in the short side direction overlap the slit 36 of the common electrode 518, vertical electric fields are favorably generated through the slit 36 of the common electrode 518 between the ends of the counter electrode 534 in the short side direction and the pixel electrodes 515. These vertical electric fields make it possible to suitably reduce horizontal electric fields generated between the pixel electrodes 515 adjacent to each other in the short side direction.

### Other Embodiments

The present technology is not limited to the embodiment described above with reference to the drawings. The following embodiments may be included in the technical scope.

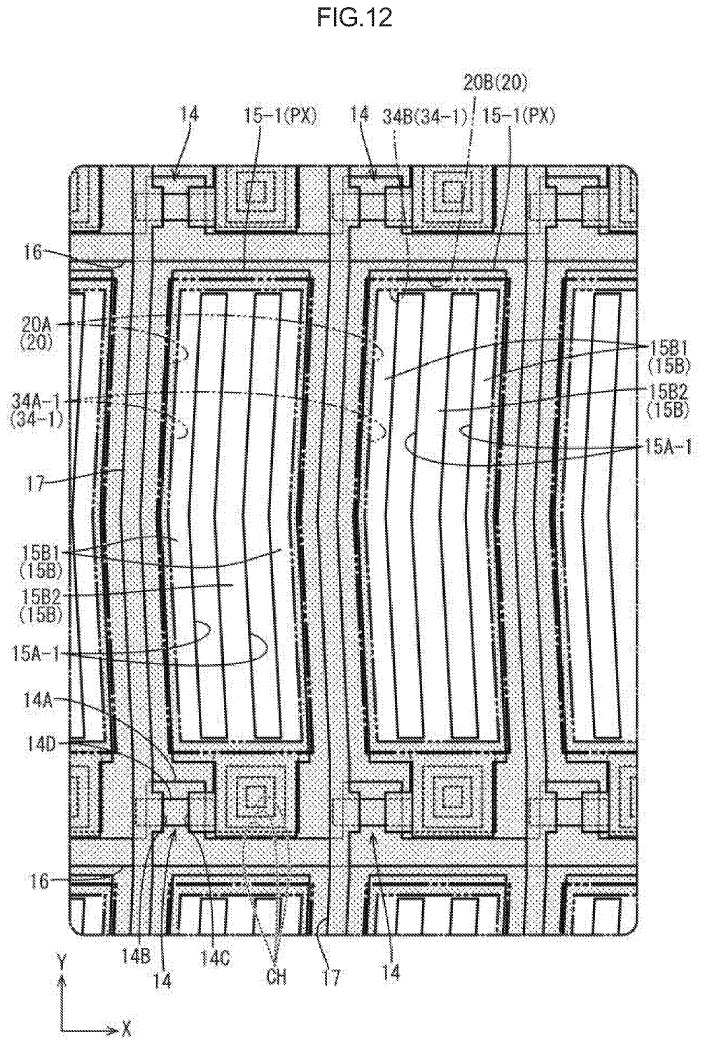

(1) According to a modification of Embodiment 1 described above, as shown in FIG. 12, source lines 17-1 may be non-linearly routed. Each of these source lines 17-1 is repeatedly bent halfway so that a larger part thereof zigzags while extending diagonally to the Y-axis direction. In this case, it is preferable that pixel electrodes 15-1, slits 15A-1, and a first electrode section 34A-1 of a counter electrode 34-1 be in planar shapes bent halfway in the Y-axis direction in the track of the source lines 17.

(2) Besides the illustration in (1) described above, the angle of bending and the frequency of bending of each source line (number of times each pixel electrode is bent) and the like may be changed as appropriate, and according to those changes, the planar shapes of the pixel electrodes and the slits may be changed.

(3) Although (1) described above has shown a case where the first electrode section of the counter electrode zigzags in the track of the planer shapes of the pixel electrodes, there may be a configuration in which the first electrode section extends linearly along the Y-axis direction regardless of the zigzag pixel electrodes. That is, there may be a configuration in which a range of overlap of the first electrode section with the pixel electrodes varies according to the positions of the pixel electrodes in the long side direction.

(4) Although each of he embodiments described above has shown a case where the first electrode section of the counter electrode overlaps parts of the end-side segmented electrodes of each pixel electrode, there may be a configuration in which the first electrode section overlaps the whole area of the end-side segmented electrodes. Furthermore, there may be a configuration in which the first electrode section overlaps a part of the center-side segmented electrode but does not overlap the remaining part of the center-side segmented electrode.

(5) Although each of the embodiments described above has shown a case where ranges of overlap between the first electrode section of the counter electrode and two pixel electrodes adjacent to each other in the X-axis direction are equal to each other, these ranges of overlap may be set to be different from each other. That is, the first electrode section may be eccentrically located closer to either of the two pixel electrodes adjacent to each other in the X-axis direction.

(6) Although each of the embodiments described above (excluding Embodiment 6) has shown a case where each pixel electrode has two slits formed therein, the number of slits that are formed in each pixel electrode may be one or not less than three. In that case, the number of side-end and center-side segmented electrodes of each pixel electrode varies according to the number of slits.

(7) Although each of the embodiments described above has shown a case where the first electrode section of the counter electrode and the first light-blocking section of the light-blocking section are different in width dimension from each other, they may be equal in width dimension to each other. Further, a magnitude relationship in width dimension between. the second electrode section and the second light-blocking section may be changed as appropriate besides the illustration.

(8) Although each of the embodiments described above has shown a case where the direction of extension of ends of each pixel electrode in the short side direction and the direction of extension of the slits are parallel to each other, these directions of extension may be in such a relationship as to cross each other. For example, the direction of extension of the slits may be parallel to the X-axis direction (i.e. the short side direction of each pixel electrode) or may be parallel to a direction diagonal to the X-axis direction and the Y-axis direction.

(9) Although each of the embodiments described above has shown a configuration in which the long side direction of the pixel electrodes and the direction of extension of the source lines are the same and the short side direction of the pixel electrodes and the direction of extension of the gate lines are the same, there may be a configuration in which the long side direction of the pixel electrodes and the direction of extension of the gate lines are the same and the short side direction of the pixel electrodes and the direction of extension of the source lines are the same. Even in that case, for retention of the isotropic planar placement of one display pixel, it is preferable to employ a configuration in which the direction of arrangement of color filters (pixel sections) that exhibit different colors is the same as the short side direction of the pixel electrodes.

(10) Although each of the embodiments described above has shown a configuration in which the first electrode section of the counter electrode overlaps pixel electrodes that constitute adjacent pixel sections that exhibit different colors, there may be a configuration in which the first electrode section of the counter electrode overlaps pixel electrodes that constitute adjacent pixel sections that exhibit the same color.

(11) Although each of the embodiments described above has shown a case where the counter electrode includes the first electrode section and the second electrode section, the second electrode section may be omitted from the counter electrode so that the counter electrode includes only the first electrode section.

(12) Embodiment 5 described above provides an illustration premised on the configuration described in Embodiment 3 (i.e. the configuration in which one first light-blocking section is wider in width than the first electrode section), it may of course be premised on the configuration described in any one of Embodiments 1, 2, 4 and 6 and (1) described above.

(13) According to a modification of Embodiment 5 described above, the low-resistance alignment film of the side of the array substrate may be replaced by an alignment film (high-resistance alignment film) which is similar to that of Embodiment 1 or the like.

(14) Embodiment 6 described above provides an illustration premised on the configuration described in Embodiment 1, it may of course be premised on the configuration described in any one of Embodiments 2, 4, and 5 and (1) described above.

(15) Although Embodiment 6 described above has shown a case where the common electrode has three slits formed in a part thereof that overlaps each pixel electrode, the number of slits that is placed in a part of the common electrode that overlaps each pixel electrode may be changed as appropriate to a number other than three.

(16) Although each of the embodiments described above has shown a case where the number of colors of the color filter or the pixel section is three, the specific number of colors may be changed as appropriate to a different number.

(17) Besides each of the embodiments described above, specific materials for use in each metal film, each insulating film, each semiconductor film, each transparent electrode film, and the like of the array substrate may be changed as appropriate. Further, the number of insulating films that are stacked in the array substrate may be changed as appropriate.

(18) Although each of the embodiment described above has shown a case where the liquid crystal panel is a transmissive liquid crystal panel, the liquid crystal panel may a reflective liquid crystal panel or a semitransmissive liquid crystal panel.

(19) Besides each of the embodiments described above, the planar shape of the liquid crystal panel may be a horizontally long rectangle, a regular square, a circle, a semicircle, an oval, an ellipse, a trapezoid, or other shapes.

1. A liquid crystal panel comprising:
a first substrate including a plurality of pixel electrodes that have a longitudinal shape and are arranged along at least a short side direction thereof, and a common electrode that is disposed to overlap the plurality of pixel electrodes;
a second substrate disposed opposite the first substrate and including a counter electrode, the counter electrode extending along a long side direction of the pixel electrodes and having a width greater than a spacing between the pixel electrodes adjacent to each other in the short side direction and selectively overlapping ends in the short side direction of the pixel electrodes adjacent to each other in at least the short side direction; and
a liquid crystal layer sandwiched between the first substrate and the second substrate.

2. The liquid crystal panel according to claim 1, wherein the common electrode extends along at least the short side direction astride the pixel electrodes adjacent to each other in at least the short side direction.

3. The liquid crystal panel according to claim 1, wherein the second substrate includes color filters exhibiting different colors and arranged along the short side direction and disposed to overlap the plurality of pixel electrodes.

4. The liquid crystal panel according to claim 1, wherein the second substrate has a light-blocking section placed so that at least a part thereof overlaps the counter electrode and does not overlap the pixel electrodes adjacent to each other in the short side direction.

5. The liquid crystal panel according to claim 1, wherein the second substrate has a light-blocking section at least a part of which overlaps the counter electrode and overlaps ends in the short side direction of the pixel electrodes adjacent to each other in the short side direction, and
the light-blocking section has a wider range of overlap with the pixel electrodes than a range of overlap between the counter electrode and the pixel electrodes.

6. The liquid crystal panel according to claim 1, wherein the pixel electrodes are located closer to the liquid crystal layer than the common electrode.

7. The liquid crystal panel according to claim 1, wherein the common electrode is located closer to the liquid crystal layer than the pixel electrodes.

8. The liquid crystal panel according to claim 7, wherein the common electrode has a slit that extends along the long side direction, and
the counter electrode is placed so that an end thereof in the short side direction overlaps the slit.

9. The liquid crystal panel according to claim 1, wherein each of the pixel electrodes has a slit that extends along the long side direction.

10. The liquid crystal panel according to claim 9, wherein each of the pixel electrodes has a plurality of the slits formed at spacings in the short side direction and at least three segmented electrodes disposed in such a manner as to be arranged alternately with the slits, and
the counter electrode is disposed to overlap the segmented electrodes placed at ends is the short side direction but not to overlap the segmented electrode placed on a center side in the short side direction.

11. The liquid crystal panel according to claim 10, wherein each of the pixel electrodes is formed so that the segmented electrodes placed at the ends in the short side direction are wider in width than the segmented electrode placed on the center side in the short side direction.

12. The liquid crystal panel according to claim 1, wherein the second substrate has a low-resistance alignment film, disposed to overlap a side of the counter electrode that faces the liquid crystal layer, that extends along at least the short side direction.

13. The liquid crystal panel according to claim 1, wherein the counter electrode is equal in potential to the common electrode.

14. The liquid crystal panel according to claim 1, wherein the liquid crystal layer is made of a liquid crystal material whose dielectric anisotropy is negative.
